(19) United States
(12) Patent Application Publication
(10) Pub. No.: US 2003/0183040 A1
(43) Pub. Date: Oct. 2, 2003

(54) Shaft damping device

(76) Inventors: Richard A. Campen, Peoria, IL (US); Cletus M. Kinsey JR., Peoria, IL (US); Kevin J. Knox, Peoria, IL (US); Werner H. Koeslin, Peoria, IL (US)

Correspondence Address: CATERPILLAR INC., 100 N.E. ADAMS STREET, PATENT DEPT., PEORIA, IL, 616296490

(21) Appl. No.: 10/108,145

(22) Filed: Mar. 27, 2002

(51) Int. Cl. F16C 3/04

(52) U.S. Cl. 74/604

(57) ABSTRACT

A shaft damping device includes a damping ring having a splined bore, a shaft having at least one spline, and a fluid feed system. The shaft is disposed within the splined bore such that the splines of the shaft mesh with the splined bore, forming a damping space therebetween. The fluid feed system is operable to control a quantity of a fluid within the damping space.

### TECHNICAL FIELD

This invention relates to a torsional rotary damping device and, more particularly, to such a device which uses a fluid or another damping material to damp a vibration of a rotating shaft.

### BACKGROUND

In an internal combustion engine, a camshaft rotates at a high speed. Due to a length of the camshaft and the stresses imposed thereon by a lobe interacting with a cam follower, the camshaft has a tendency to vibrate, flex, twist, and wind-up developing high torsional stresses. The vibration can cause a tooth on a gear attached to the camshaft to “chatter” with a tooth on a mating gear. Vibrations cause undue wear to engine components and noisy engine operation. It is thus desirable to dampen the vibration of the camshaft.

U.S. Pat. No. 5,619,887, issued Apr. 15, 1997 to Roger T. Simpson (hereafter referenced as '887) discloses a camshaft vibration damper. The '887 device is a friction damper which uses shoes, similar to brake shoes, to dampen the vibration of the camshaft. '887 has a large number of complicated moving parts and thus may be difficult to maintain and operate, since many specialized parts will be needed as spares and there are tight clearances which must be maintained between the parts.

Accordingly, the art has sought a method and apparatus of damping a camshaft which: reduces camshaft noise and supports an outboard end of the camshaft to compensate for flexing along the length of the camshaft. The present invention is directed to overcoming one or more of the problems as set forth above.

### SUMMARY OF THE INVENTION

In an embodiment of the present invention, a camshaft damping device is disclosed. The camshaft damping device includes a damping ring having a splined bore, a camshaft having at least one spline and being disposed within the splined bore so as to define a damping space, and a fluid feed system which can control a quantity of a fluid within the damping space.

In an embodiment of the present invention, a method for damping an interface between a first spline and a second spline is disclosed. The method includes the steps of forming a damping space between the first spline and the second spline, rotating the first spline in a driving direction, rotating the second spline in a driving direction through the motion of the first spline, and controlling a quantity of fluid in the damping space.

### BRIEF DESCRIPTION OF THE DRAWINGS

FIG. 1 is an isometric front view of a damping ring of an embodiment of the present invention; and

FIG. 2 is a partial plan view of a spline interposition of an embodiment of the present invention.

### DETAILED DESCRIPTION

An embodiment of the present invention provides an apparatus and method of a camshaft damping device.

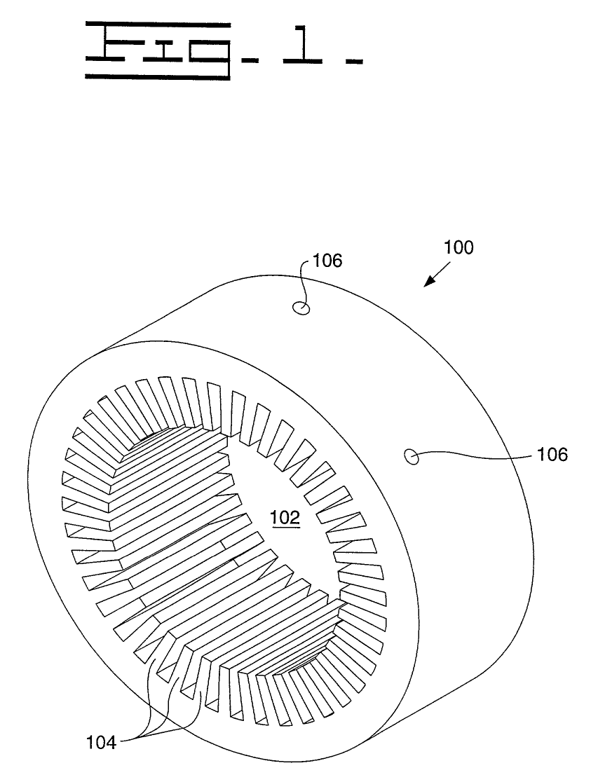

FIG. 1 shows a damping ring 100 according to the present invention. The damping ring 100 has a splined bore 102, defined by one or more ring splines 104. The term “spline” is taken herein to mean a substantially radial protrusion of any length, such as a tooth or rib, from a first element which can be placed in a meshing or alternating configuration with protrusions of a second element for the purposes of transmitting a motion between the two elements. A gearset contains an example of this type of meshing relationship. “Ring” is used herein to refer to a sleeve, gear, bearing, or other element at least partially surrounding a shaft. The splines may be of any suitable configuration or shape.

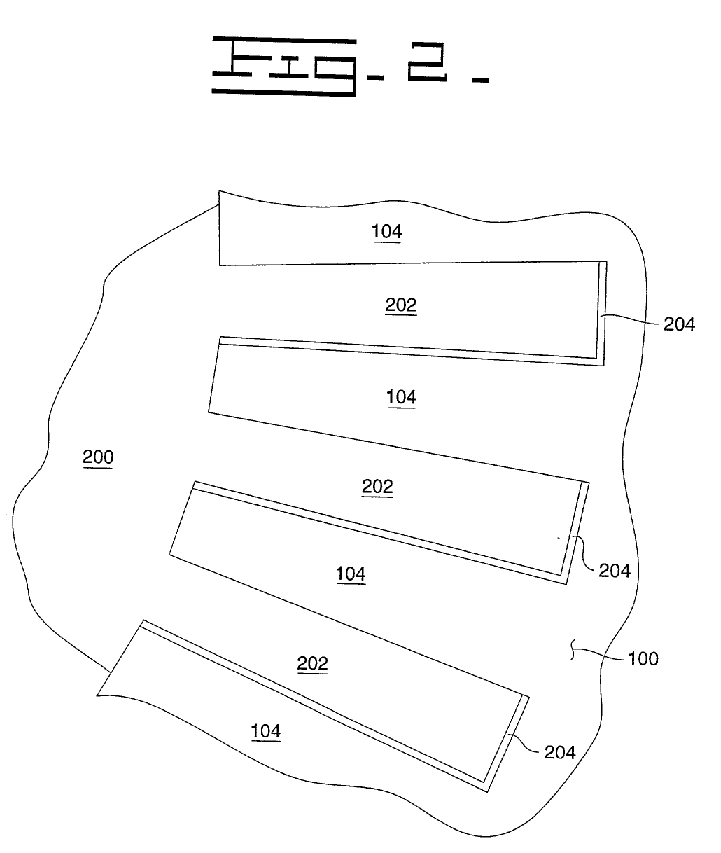

FIG. 2 illustrates the interposed relationship of the splines of the damping ring 100 and a shaft, shown and discussed here as a camshaft 200; however, the damping device could be used in an engine application on the crankshaft of an engine or in a transmission application or any other suitable application, as well. The camshaft 200 has one or more splines 202 which interpose the ring splines 104, forming a damping space 204 therebetween. A damping material is located within the damping space 204. In the present description, the damping material will be characterized as a fluid. However, a powder, gel, or foam, as well as any of a number of different types of fluid, such as oil or water, will adequately damp the motion of the camshaft 200, provided such material can absorb and dissipate vibrations from the camshaft 200. As is intuitively obvious, a damping material with a high viscosity will provide more damping force than a damping material with a low viscosity.

For proper operation of the present invention, the minimal workable configuration comprises one spline 104, 202 on one of the damping ring 100 and the camshaft 200 meshing with one spline 104, 202 on the other of the damping ring 100 and the camshaft 200. While the present invention is described as having multiple splines 104, 202 on both the damping ring 100 and the camshaft 200, it should be understood that the minimal configuration described above would still be considered an embodiment of the present invention. However, the one spline to one spline system would operate efficiently only on a shaft which travels substantially in one direction. Should the shaft travel both clockwise and counterclockwise in the course of operation, greater efficiency would be achieved through the use of a pair of splines 104, 202 on one of the damping ring 100 and the camshaft 200 meshing with one spline 104, 202 on the other of the damping ring 100 and the camshaft 200.

A fluid feed system controls a quantity of fluid within the damping space 204. The control could be accomplished through, for example, one or more fluid control apertures 106 in the damping ring 100 or in the ring splines 104 which allow fluid to be added to or removed from the damping space 204. The fluid feed system control means and fluid source may be of any type which produces the desired fluid feed characteristics.

Preferably, a housing (not shown) of a known type, for example, a journal housing, encloses the damping ring 100 and at least a portion of the camshaft in a known manner to provide a fluid feed system. In this instance, the housing contains the fluid, and the quantity of fluid within the housing and/or within the damping space 204 is controlled by a fluid dam, check valve, or other known fluid control means, optionally in conjunction with one or more pressure sensors. This control may be a one-time setup or may be an ongoing process.

The damping ring 100 is preferably located near an end of the camshaft 200 to provide a stabilizing force for the torsion and vibration of the camshaft 200.

The present invention is not intended to be restricted to an engine camshaft or crankshaft application. Many different machines and application contain a shaft which is subject to similar problems to those described above, and the present invention may be used successfully to solve those problems.

### INDUSTRIAL APPLICABILITY

As the camshaft 200 rotates, the damping ring 100 also rotates, due to the interlocking of the splined bore 102 and the splines 202 of the camshaft 200. The fluid feed system controls the quantity of fluid within the damping space 204 to provide a preestablished damping characteristic.

As the splines 202 vibrate with the camshaft 200, the quantity and viscosity of fluid within the damping space 204 provides a controllable resistance to the motion of the splines 202. This resistance can be supplemented by the use of the spline 202 motion to move or pump the fluid from one area of the damping space 204 to another. The resistance provides the desired damping characteristic to the camshaft 200. The fluid feed system can be controlled to provide more or less resistance by controlling a quantity or viscosity of fluid in the fluid feed system in a known manner—more, or more viscous, fluid gives more resistance and less, or less viscous, fluid gives less resistance.

The apparatus and method of the present invention reduces noise, flexing along the length of the shaft, and is simple and inexpensive to manufacture and operate. Other aspects, objects, and advantages of the present invention can be obtained from a study of the drawings, the disclosure, and the appended claims.

What is claimed is:

1. A damping device adapted for use with a shaft, comprising:
a damping ring having a splined bore therethrough;
at least one spline positioned on the shaft and disposed within the splined bore such that a spline of the shaft is interposed the splined bore forming a damping space therebetween; and
a fluid feed system operable to control a quantity of a fluid within the damping space.

2. The damping device of claim 1, wherein the fluid feed system includes a housing substantially enclosing the damping ring, wherein the fluid is located within the housing.

3. The damping device of claim 1, wherein the fluid is one or more of oil, water, foam, gel, or powder.

4. The damping device of claim 1, wherein the fluid feed system produces a preestablished damping characteristic by controlling the quantity of fluid in the damping space.

5. The damping device of claim 4, wherein the fluid feed system controls the quantity of fluid in the damping space with a fluid pressure sensor and one or more of a pump, sump, valve, or dam plate.

6. The damping device of claim 4, wherein a decreasing quantity of fluid provides less damping and an increasing quantity of fluid provides greater damping.

7. An engine having a crankshaft, a camshaft, at least one combustion cylinder, and a shaft damping system, the shaft damping system comprising:
a damping ring having a splined bore therethrough;
at least one of the crankshaft and the camshaft having at least one spline disposed within the splined bore such that the splines of the at least one of the crankshaft and the camshaft are interposed the splined bore forming a damping space therebetween; and
a fluid feed system operable to control a quantity of a fluid flowing through the damping space.

8. The engine of claim 7, including a housing substantially enclosing the damping ring and at least a portion of the camshaft, wherein the fluid is extant within the housing.

9. The engine of claim 7, wherein the fluid is one or more of oil, water, foam, gel, or powder.

10. The engine of claim 7, wherein the fluid feed system produces a preestablished damping characteristic by controlling the quantity of fluid in the damping space.

11. The engine of claim 10, wherein a decreased quantity of fluid produces less damping resistance and an increased quantity of fluid provides more damping resistance.

12. The engine of claim 10, wherein the fluid feed system controls the quantity of fluid in the damping space with a fluid pressure sensor and one or more of a pump, sump, valve, or dam plate.

13. A method for damping an interface between a first spline and a second spline, comprising the steps of:
forming a damping space between the first spline and the second spline;
rotating the first spline in a driving direction;
rotating the second spline in a driving direction through the motion of the first spline; and
controlling a quantity of fluid in the damping space.

14. The method of claim 13, including the step of:
forming a damping space between the first spline and a third spline on an opposing side of the first spline from the second spline.

15. The method of claim 13, including the step of:
rotating the first spline in a driving direction through the motion of a shaft; and
using the shaft as one or more of a camshaft of an engine and a crankshaft of an engine.

16. The method of claim 13, wherein controlling the quantity of fluid includes:
increasing the quantity of fluid.

17. The method of claim 13, wherein controlling the quantity of fluid includes:
decreasing the quantity of fluid.

18. The method of claim 13, further including the step of:
controlling the viscosity of fluid.

19. The method of claim 18, wherein controlling the viscosity of fluid includes:
increasing the viscosity of fluid.

20. The method of claim 18, wherein controlling the viscosity of fluid includes:
decreasing the viscosity of fluid.
